(19) United States
(12) Patent Application Publication
(10) Pub. No.: US 2024/0010193 A1
(43) Pub. Date: Jan. 11, 2024

(54) VEHICLE CONTROL APPARATUS

(71) Applicant: Hino Motors, Ltd., Hino-shi (JP)

(72) Inventors: Yuichiro HIROSE, Hino-shi (JP); Kozue KOBAYASHI, Hino-shi (JP); Takahiro SUZUKI, Hino-shi (JP); Satoshi KURODA, Hino-shi (JP); Sung Chun TSAI, Hino-shi (JP)

(73) Assignee: Hino Motors, Ltd., Hino-shi (JP)

(21) Appl. No.: 18/254,306

(22) PCT Filed: Nov. 29, 2021
(86) PCT No.: PCT/JP2021/043605

§ 371 Date: May 24, 2023

(30) Foreign Application Priority Data
Dec. 1, 2020 (JP) 2020-199749

(51) Int. Cl. B60W 30/09; B60W 30/095; B60W 30/14; B60W 30/18

(52) U.S. Cl. CPC B60W 30/09; B60W 30/0956; B60W 30/146; B60W 30/18154; B60W 2552/53; B60W 2554/4029; B60W 2556/40

(57) ABSTRACT

A vehicle control apparatus includes a host vehicle position recognizer, a moving object recognizer, a map database, an influence recognizer configured to recognize an influence of a moving object around the host vehicle traveling along a target path of the host vehicle, and a vehicle controller configured to decelerate the host vehicle to avoid collision with the moving object based on the influence. Map information includes area information regarding a plurality of areas on the map for specifying the moving object that is a target of recognizing the influence. When the host vehicle position satisfies predetermined host vehicle position conditions set in advance for each area, the influence recognizer recognizes the influence of the moving object present in the area where the host vehicle position satisfies the host vehicle position conditions, based on the host vehicle position, the area information, and the recognition result from the moving object recognizer.

### TECHNICAL FIELD

The present disclosure relates to a vehicle control apparatus.

### BACKGROUND ART

Patent Literature 1 discloses a driving assistance apparatus that performs driving assistance when entering an intersection based on the degree of recognition of the presence of a host vehicle by a driver of another vehicle at the intersection.

### CITATION LIST

### Patent Literature

[Patent Document 1] Japanese Unexamined Patent Publication No. 2007-200052

### SUMMARY OF INVENTION

### Technical Problems

Incidentally, in vehicle control for causing a host vehicle to travel along a target path, it is conceivable to decelerate the host vehicle to avoid collision with a moving object when the moving object around the host vehicle is present on the target path of the host vehicle or in a lane in which the host vehicle is traveling. In this case, by considering moving objects that are neither on the target path of the host vehicle nor in the lane in which the host vehicle is traveling, for example, it is expected to prevent a situation where the host vehicle is forced to brake suddenly or stop suddenly at an intersection. It is expected to not obstruct traffic of moving objects. However, considering such moving objects indefinitely (for example, over the entire sensing range of the external sensor) tends to increase a computational load.

The present disclosure describes a vehicle control apparatus capable of reducing obstruction of traffic of moving objects around a host vehicle while suppressing an increase in a computational load.

### Solution to Problem

According to an aspect of the present disclosure, there is provided a vehicle control apparatus including a host vehicle position recognizer configured to recognize a host vehicle position that is a position of a host vehicle on a map; a moving object recognizer configured to recognize a moving object around the host vehicle; a map database that stores map information; an influence recognizer configured to recognize an influence of the moving object on the host vehicle traveling along a target path of the host vehicle based on a recognition result from the moving object recognizer and the target path; and a vehicle controller configured to decelerate the host vehicle to avoid collision with the moving object based on the recognition result from the influence recognizer, in which the map information includes area information regarding a plurality of areas on the map for specifying the moving object that is a target of recognizing the influence, and when the host vehicle position satisfies predetermined host vehicle position conditions set in advance for each area the influence recognizer recognizes the influence of the moving object present in the area where the host vehicle position satisfies the host vehicle position conditions, based on the host vehicle position, the area information, and the recognition result from the moving object recognizer.

The vehicle control apparatus according to the aspect of the present disclosure recognizes the influence of a moving object on the host vehicle, the moving object being a moving object that is present neither on a target path of the host vehicle nor in a lane in which the host vehicle is traveling. As a result, the host vehicle can be decelerated at an early stage to avoid the collision, for example, in a case where there is a risk of collision with such a moving object. Since sudden braking can be prevented, it is possible to reduce obstruction of traffic of moving objects around the host vehicle. A target area that is a target of recognition of the influence is an area where the host vehicle position satisfies predetermined host vehicle position conditions set in advance for each area. As described above, since the influence is recognized by limiting a target area, it is possible to suppress an increase in a computational load compared with a case of recognizing the influence without area limitation, for example. Therefore, according to the aspect of the present disclosure, it is possible to reduce obstruction of traffic of moving objects around the host vehicle while suppressing an increase in a computational load.

In one embodiment, the areas may be preset as closed regions on the map. For example, in a case where the area is a preset open region, an additional computation process is required to be used for recognition of the influence. In contrast, according to the vehicle control apparatus, the computational load can be reduced compared with a case where the area is an open region.

In one embodiment, the areas may be preset as fixed regions on the map. For example, in a case where the area is a region that is not fixed on the map, the area moves on the map in accordance with movement of the host vehicle position moment by moment as the host vehicle is traveling. In a case where the area moves, an additional computation process is required. In contrast, according to the vehicle control apparatus, the computational load can be reduced compared with a case where the area is a region that is not fixed on the map.

In one embodiment, the map information may include stop position information regarding a stop position where the host vehicle is temporarily stopped on a roadway, and the vehicle controller may stop the host vehicle ahead of the stop position based on the stop position information and the host vehicle position when the host vehicle is decelerated to avoid collision with the moving object. In this case, for example, when the host vehicle approaches the stop position in a case where the host vehicle is decelerated, the host vehicle can be appropriately stopped at the stop position.

In one embodiment, the areas may include a crosswalk area, and the vehicle controller may stop the host vehicle ahead of the stop position when the moving object present in the crosswalk area is a pedestrian. For example, in a case where the host vehicle is not stopped ahead of the stop position, a computation process is required to further compute a risk of collision between the moving object present in the crosswalk area and the host vehicle. In contrast, according to the vehicle control apparatus, the computational load can be reduced compared with a case where the host vehicle is not stopped ahead of the stop position.

In one embodiment, the areas may include a crosswalk area, and the crosswalk area may include a first crosswalk area in a case where the host vehicle is located past the stop position in an advancing direction and a second crosswalk area in a case where the host vehicle is located ahead of the stop position in the advancing direction, with respect to one crosswalk. In this case, details of the vehicle control for the host vehicle with respect to one crosswalk may be varied according to on which side of the stop position the host vehicle is located in the advancing direction.

In one embodiment, the areas may include a host vehicle protrusion area preset for an intersection where a host vehicle trajectory protrudes into an oncoming lane in a case where the host vehicle turns left, and the vehicle controller may decelerate the host vehicle to avoid collision with the moving object when the moving object is present in the host vehicle protrusion area. For example, in a case where the host vehicle is not decelerated to avoid collision with a moving object, a computation process is required to further compute interference between the host vehicle protrusion area and the host vehicle trajectory. In contrast, according to the vehicle control apparatus, the computational load can be reduced compared with a case where the host vehicle is not decelerated to avoid collision with a moving object.

### Advantageous Effects of Invention

According to the vehicle control apparatus related to various aspects of the present disclosure, it is possible to reduce obstruction of traffic of moving objects around a host vehicle while suppressing an increase in computational load.

### BRIEF DESCRIPTION OF DRAWINGS

FIG. 1 is a block diagram illustrating a vehicle control apparatus according to an embodiment.

FIG. 2 is a plan view exemplifying a scene in which a host vehicle enters a roundabout.

FIG. 3 is a plan view exemplifying a scene in which a host vehicle entering a crosswalk is located ahead of a stop line.

FIG. 4 is a plan view exemplifying a scene in which the host vehicle entering the crosswalk crosses the stop line.

FIG. 5 is a plan view exemplifying a scene in which a host vehicle that is about to turn right at an intersection is located ahead of a stop line.

FIG. 6 is a plan view exemplifying a scene in which the host vehicle that is about to turn right at the intersection, crosses the stop line.

FIG. 7 is a plan view exemplifying a scene in which a trajectory of a host vehicle that is about to turn left at an intersection protrudes into an oncoming lane.

FIG. 8 is a plan view illustrating an example of an area setting method.

FIG. 9 is a flowchart illustrating an example of an autonomous driving process of the vehicle control apparatus of FIG. 1.

FIG. 10 is a flowchart illustrating an example of a collision avoidance process of the vehicle control apparatus in FIG. 1.

FIG. 11 is a flowchart exemplifying a process according to a first type.

FIG. 12 is a flowchart exemplifying a process according to a second type.

FIG. 13 is a flowchart exemplifying a process according to a third type.

### DESCRIPTION OF EMBODIMENTS

Hereinafter, a vehicle control apparatus according to an embodiment of the present disclosure will be described in detail with reference to the drawings.

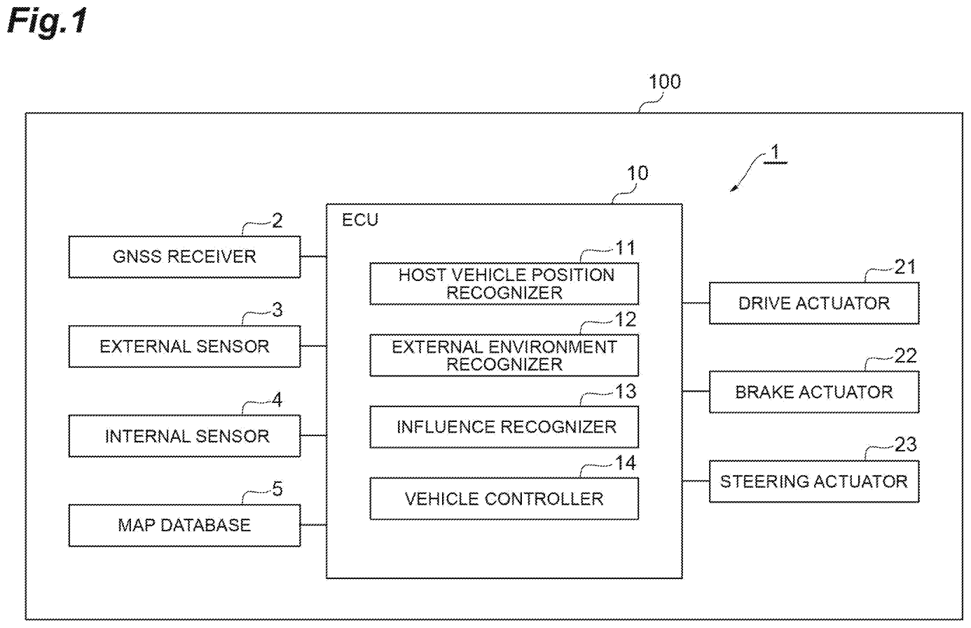

A vehicle control apparatus 1 illustrated in FIG. 1 is mounted on a host vehicle 100. As an example, the host vehicle 100 is configured to be able to execute vehicle control for causing the host vehicle 100 to travel along a target path. The vehicle control includes, for example, autonomous driving control in which the host vehicle 100 autonomously travels toward a preset destination without a driver performing a driving operation.

The host vehicle 100 is, for example, a freight vehicle such as a truck, a bus, or a trailer. Examples of the host vehicle 100 include a vehicle having only an internal combustion engine as a power source, an electric hybrid vehicle having both an internal combustion engine and an electric motor as power sources, and an electric vehicle and a fuel cell vehicle having only an electric motor as power sources.

The vehicle control apparatus 1 includes a global navigation satellite system [GNSS] receiver 2, an external sensor 3, an internal sensor 4, a map database 5, an electronic control unit [ECU] 10, a drive actuator 21, a brake actuator 22, and a steering actuator 23.

The GNSS receiver 2 receives signals from, for example, four or more positioning satellites, and acquires position information indicating a position of the host vehicle 100. The position information includes, for example, latitude and longitude. The GNSS receiver 2 outputs the acquired position information of the host vehicle 100 to the ECU 10.

The external sensor 3 is a detection device that detects a situation around the host vehicle 100. The external sensor 3 includes at least one of a camera, a millimeter wave radar, or a light detection and ranging [LiDAR].

The camera is an imaging device that captures an image of an external environment of the host vehicle 100, and is provided on the rear side of a windshield of the host vehicle 100, for example. The camera transmits imaging information regarding the external environment of the host vehicle 100 to the ECU 10. The camera may be a monocular camera or a stereo camera. The millimeter wave radar or the LiDAR is a detection device that detects objects including moving objects around the host vehicle 100 by using radio waves (for example, millimeter waves) or light. The millimeter wave radar or the LiDAR transmits radio waves or light around the host vehicle 100, receives the radio waves or the light reflected by an object, detects moving objects and stationary objects, and transmits detection information to the ECU 10.

Examples of moving objects include other vehicles, pedestrians, light vehicles such as bicycles, and streetcars. Moving objects are not limited to these. A moving object does not necessarily have to be constantly moving. For example, in a case where a moving pedestrian temporarily stops on a crosswalk, the external sensor 3 may detect the pedestrian as a moving object even in a case where the pedestrian is strictly stationary.

The internal sensor 4 is a detection device that detects a traveling state of the host vehicle 100. The internal sensor 4 includes a vehicle speed sensor, an acceleration sensor, and a rotation angular velocity sensor. The acceleration sensor is a detector that detects an acceleration of host vehicle 100. The rotation angular velocity sensor is an inertial measurement unit [iMU] that detects a rotation angular velocity around a predetermined axis passing through the center of gravity of the host vehicle 100 (for example, a yaw rate around a vertical axis). The vehicle speed sensor, the acceleration sensor, and the rotation angular velocity sensor transmit the detected information regarding the traveling state to the ECU 10.

The map database 5 is a database that stores map information. The map database 5 is formed in a storage medium such as a hard disk drive [HDD] mounted on the host vehicle 100, for example. The map information includes road position information, road shape information (for example, a curve, the type of straight section, a curvature radius of a curve, an intersection shape, and lane width), intersection and branch point position information, and structure position information, and the like. Structures include facilities such as shops provided along roads. The map database 5 may be formed in a computer of a facility such as a management center that can communicate with the host vehicle 100. The map information will be described later in more detail.

The ECU 10 is an electronic control unit having a central processing unit [CPU], a read only memory [ROM], a random access memory [RAM], a Controller Area Network [CAN] communication circuit, and the like. In the ECU 10, for example, programs stored in the ROM are loaded into the RAM, and the programs loaded into the RAM are executed by the CPU. The ECU 10 realizes various functions. The ECU 10 may be configured with a plurality of electronic units. A functional configuration of the ECU 10 will be described later in more detail.

The drive actuator 21 controls the drive force of the host vehicle 100 by controlling a power source such as an engine in response to a control signal from the ECU 10. The brake actuator 22 controls the braking force applied to wheels of the host vehicle 100 by controlling a brake system (for example, a hydraulic brake system) in response to a control signal from the ECU 10. The steering actuator 23 controls driving of a motor that controls steering torque in an electric power steering system in response to a control signal from the ECU 10.

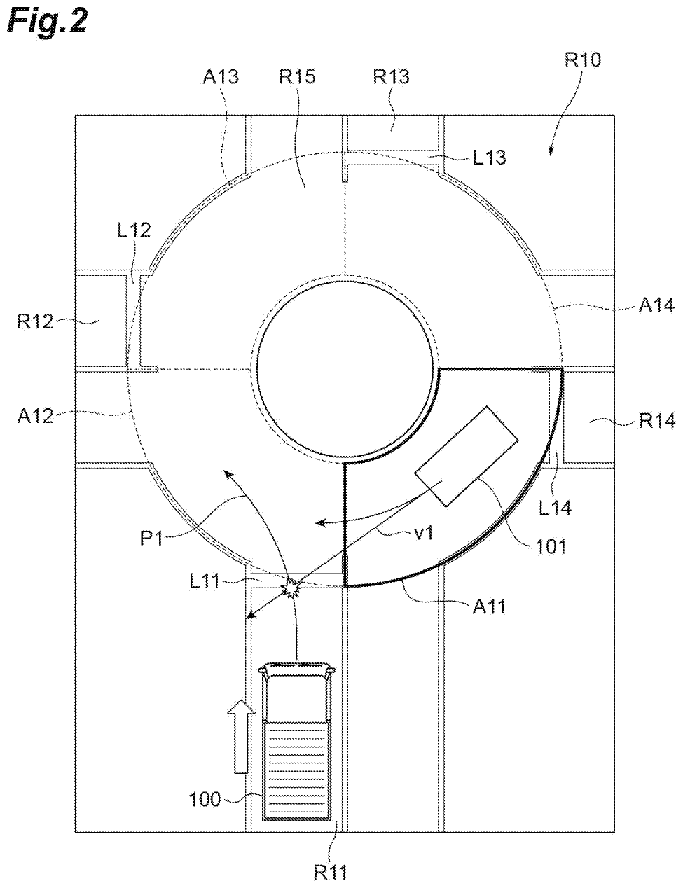

Area information included in the map information will be described with reference to FIGS. 2 to 9. The map information includes area information regarding a plurality of areas on a map for specifying a moving object that is a target of recognizing the influence. The area is a region on the map in which there is a realistic possibility that a moving object is advancing to interfere with a lane or a path on which the host vehicle is traveling. On the map, a plurality of areas are respectively associated with a plurality of lanes or paths on which the host vehicle may be located. The area is set in advance as a fixed region on the map, for example. The area is set in advance as a closed region on the map, for example. The closed region is a region having the finite area. Areas may be set separately according to the types of moving objects, or may be set as a region common to different types of moving objects.

FIG. 2 is a plan view exemplifying a scene in which the host vehicle enters a roundabout. FIG. 2 exemplifies a lane R11 in which the host vehicle 100 is located and other lanes R12, R13, and R14 as lanes extending radially connected to a roundabout R10. Vehicles located in the lanes R11 to R14 can enter a circular lane R15 after temporarily stopping at stop lines L11 to L14, respectively. That is, the map information includes position information of the stop lines L11 to L14 on the lanes R11 to R14 as stop position information regarding the stop position where the host vehicle temporarily stops on a roadway. The circular lane R15 is a lane in which a vehicle can travel clockwise, for example, in a plan view.

In FIG. 2, as an example, four areas A11 to A14 are provided along the circular lane R15. The areas A11 to A14 are sector-shaped regions having circumferential dimensions that equally divide the circular lane R15 corresponding to lanes R11 to R14 and width dimensions that are approximately equal to a lane width of the circular lane R15.

The area A11 is an upstream area located upstream in the traveling direction of the circular lane R15 when viewed from the lane R11. Thus, in a case where the host vehicle 100 is located in the lane R11, the other vehicle 101 located in the area A11 is a moving object that is neither on a target path P1 of the host vehicle 100 nor in the lane R11 in which the host vehicle 100 is traveling. The target path P1 here may be a future target path within a predetermined time from the present. In other words, the predetermined time may be set such that, even in a case where the host vehicle 100 is traveling along the path that circles the circular lane R15, “the area A11 does not exist on the target path P1”.

Circumferential dimensions of the areas A11 to A14 may be dimensions corresponding to a presence range of another vehicle that may realistically interfere with a possible future trajectory of the host vehicle located in any of the lanes R11 to R14, by taking into account a speed limit on the circular lane R15. Shapes and dimensions of the areas A1l to A14 are not limited to the above examples.

Predetermined host vehicle position conditions are set in advance for each of the areas A11 to A14. For example, host vehicle position conditions that are satisfied when a host vehicle position of the host vehicle 100 located in the lane RI 1 approaches a position a predetermined distance (for example, 5 m) ahead of the stop line L11 may be set in the area A11.

Similarly, the area A12 is an upstream area located upstream in the traveling direction of the circular lane R15 when viewed from the lane R12. In the area A12, host vehicle position conditions are set for a host vehicle position of the host vehicle located in the lane R12, for example. The area A13 is an upstream area located upstream in the traveling direction of the circular lane R15 when viewed from lane R13. In the area A13, host vehicle position conditions are set for a host vehicle position of the host vehicle located in the lane R13, for example. The area A14 is an upstream area located upstream in the traveling direction of circular lane R15 when viewed from lane R14. In the area A14, host vehicle position conditions are set for a host vehicle position of the host vehicle located in the lane R14, for example.

Area information of a first type is assigned to the areas A11 to A14. The first type and second and third types that will be described later are the types of areas for differentiating processes of the ECU 10 that will be described later. The first, second, and third types are assigned to each area according to characteristics of an area and a moving object. In a case where the area information of the first type is assigned, it is determined whether or not there is a risk of collision between a moving object in the area and the host vehicle 100 as recognition of influence. In a case where there is a risk of collision, vehicle control is performed by decelerating the host vehicle 100 to avoid collision.

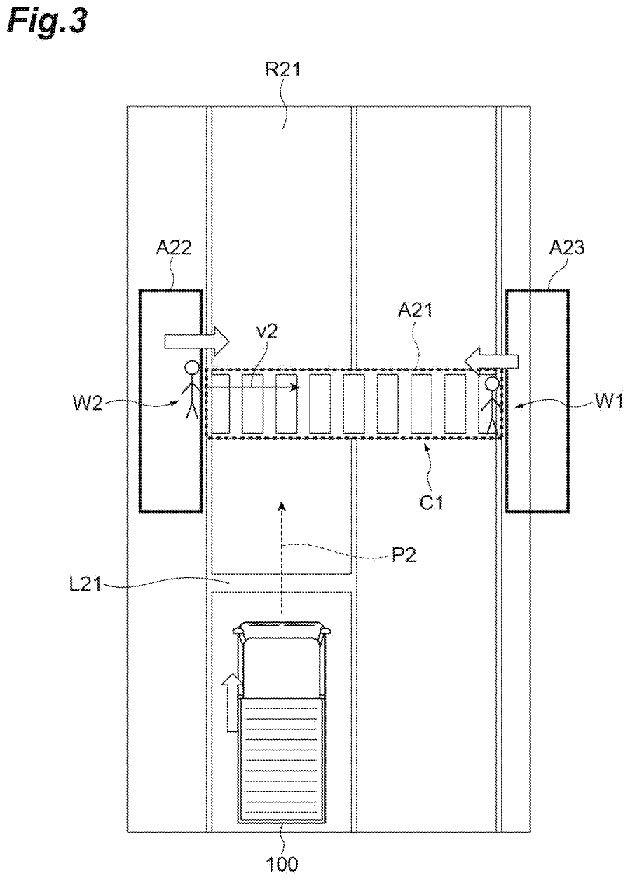

FIG. 3 is a plan view exemplifying a scene in which the host vehicle entering a crosswalk is located ahead of a stop line. FIG. 3 exemplifies a lane R21 in which the host vehicle 100 is located as a lane extending to cross a crosswalk C1. A stop line L21 is provided in the lane R21. That is, the areas include a crosswalk area, and the map information includes position information of the stop line L21 in the lane R21 as stop position information.

In FIG. 3, as an example, a rectangular area A21 surrounding the crosswalk C1 is provided. The area A21 is a second crosswalk area that is an area in a case where the host vehicle 100 is located ahead of the stop line L21 in the advancing direction. In the area A21, a dimension of the host vehicle 100 in the advancing direction (a width direction of the crosswalk) is set to a dimension in which a predetermined margin width is added to the width of the crosswalk in consideration of a sensing error of the external sensor 3. The area A21 is not limited to a rectangular shape.

At both ends of the crosswalk C1, for example, rectangular areas A22 and A23 are provided on the sidewalk as crossing preparation areas where pedestrians and the like who want to cross the crosswalk C1 can be located. Dimensions of areas A22 and A23 are dimensions corresponding to a presence range of a pedestrian or the like that may realistically interfere with a possible future trajectory of the host vehicle located in the lane R21 inconsideration of a maximum speed of pedestrians and the like. The areas A22 and A23 are not limited to rectangular shapes.

Predetermined host vehicle position conditions are set in advance for each of the areas A21 to A23. For example, host vehicle position conditions that are satisfied when a host vehicle position of the host vehicle 100 located in the lane R21 approaches a position a predetermined distance (for example, 5 m) ahead of the stop line L21 may be set in the area A21.

In the example in FIG. 3, the host vehicle 100 located in the lane R21 has not yet passed the stop line L21, and can thus enter the crosswalk C1 after temporarily stopping at the stop line L21. In a case where the host vehicle 100 is located in the lane R21, a pedestrian W1 located in the area A21 and a pedestrian W2 located in the area A22 are moving objects that are present neither on a target path P2 of the host vehicle 100 nor within the lane R21 in which the host vehicle 100 is traveling. A pedestrian as a moving object may stop temporarily.

Area information of the second type is assigned to the area A21 that is a second crosswalk area. In the case of the second type, in a case where a moving object in the crosswalk is a pedestrian, without determining whether there is a risk of collision between the moving object in the area and the host vehicle 100, vehicle control is performed to decelerate the host vehicle 100 to be stopped ahead of the stop line L21 in order to prioritize crossing of the pedestrian. Area information of the first type is assigned to the areas A22 and A23.

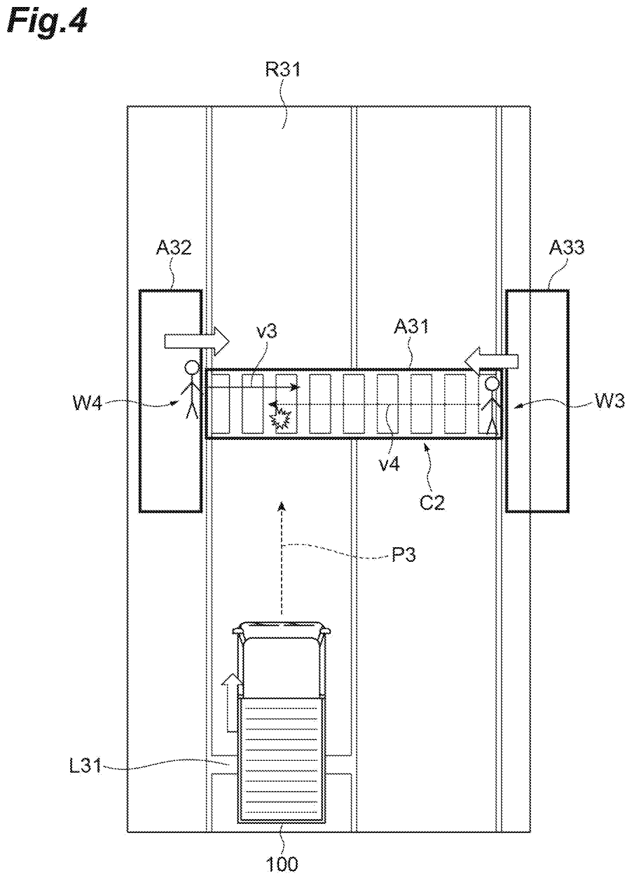

FIG. 4 is a plan view exemplifying a scene in which the host vehicle entering a crosswalk is crossing a stop line. FIG. 4 exemplifies a lane R31 in which the host vehicle 100 is located as a lane extending to cross the crosswalk C2. A stop line L31 is provided in the lane R31. That is, the map information includes position information of the stop line L31 in the lane R31 as stop position information.

In FIG. 4, as an example, a rectangular area A31 surrounding the crosswalk C2 is provided. The area A31 is a first crosswalk area that is an area in a case where the host vehicle 100 is located past the stop line L31 in the advancing direction. A dimension of the area A31 is not particularly limited, but may be the same as the dimension of the area A21.

At both ends of the crosswalk C2, areas A32 and A33 that are crossing preparation areas are provided on the sidewalks in the same manner as the areas A22 and A23. Dimensions of the areas A32 and A33 are not particularly limited, but may be the same as the dimensions of the areas A22 and A23.

Predetermined host vehicle position conditions are set in advance for each of the areas A31 to A33. For example, host vehicle position conditions that are satisfied in a case where a host vehicle position of the host vehicle 100 located in lane R31 is between the crosswalk C2 and the stop line L31 may be set in the area A31.

In the example in FIG. 4, the host vehicle 100 located in the lane R31 is crossing the stop line L31 and thus approaches the crosswalk C2 without temporarily stopping at the stop line L31. In a case where the host vehicle 100 is located in the lane R31, a pedestrian W3 located in the area A31 and a pedestrian W4 located in the area A32 are moving objects that are present neither on a target path P3 of the host vehicle 100 nor within the lane R31 in which the host vehicle 100 is traveling.

Area information of the first type is assigned to the area A2 that is a first crosswalk area. In this case, as recognition of influence, it is determined whether or not there is a risk of collision between a moving object (for example, pedestrian W3) in the crosswalk and the host vehicle 100. In a case where there is a risk of collision, vehicle control is performed by decelerating the host vehicle 100 to avoid collision. Therefore, in a case where the possibility of a collision is small, such as when the host vehicle 100 is about to pass the crosswalk C2 and a pedestrian begins to cross, the vehicle control for collision avoidance of the host vehicle 100 may be omitted. The area information of the first type is also assigned to areas A32 and A33.

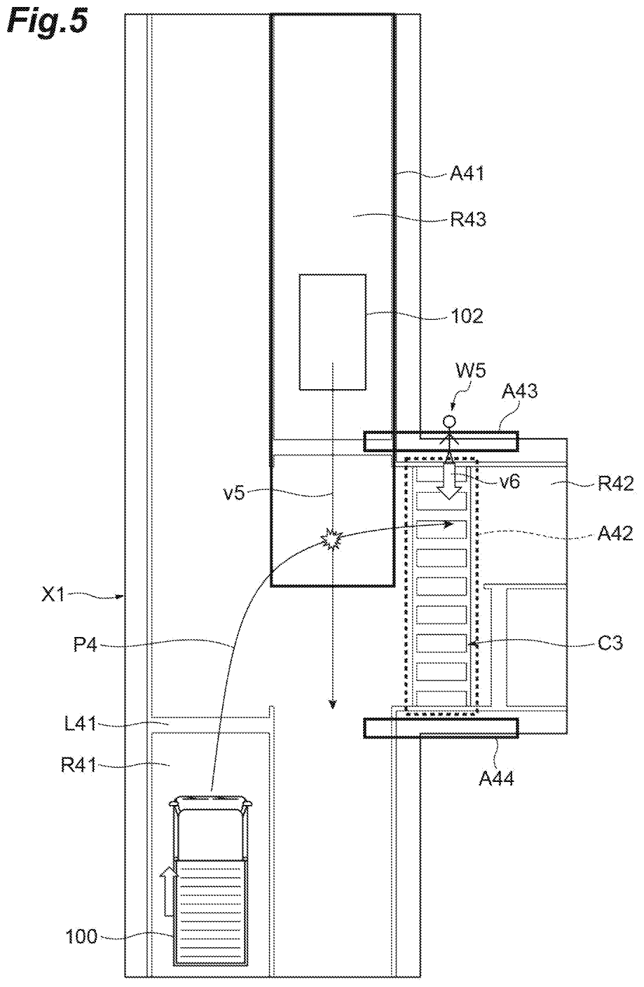

FIG. 5 is a plan view exemplifying a scene in which the host vehicle that is about to turn right at an intersection is located ahead of the stop line. FIG. 5 exemplifies a lane R41 as a lane in which the host vehicle 100 is located, and a lane R42 as a lane toward which the host vehicle 100 turns right. A crosswalk C3 extends across the lane R42. A stop line L41 is provided in the lane R41. That is, the map information includes position information of the stop line L41 in the lane R41 as stop position information.

In FIG. 5, as an example, an area A41 is provided on an oncoming lane R43 that can enter an intersection X1. The area A41 is an oncoming lane area that is an area in a case where the host vehicle is located within a predetermined distance ahead of the stop line L41 in the advancing direction or within the intersection X1 at the entrance of the intersection X1.

The area A41 is, for example, a rectangular region having a width dimension that is substantially the same as a width of the oncoming lane R43. A dimension of the area A41 in the direction in which the lane extends is a dimension corresponding to a presence range of another vehicle 102 that may actually interfere with a possible future trajectory of the host vehicle 100 located in the lane R41 in consideration of a speed limit in the oncoming lane R43. The area A41 is not limited to a rectangular shape, and may have any shape along the oncoming lane R43.

In FIG. 5, a rectangular area A42 surrounding the crosswalk C3 is provided. The area A42 is a second crosswalk area that is an area in a case where the host vehicle 100 is located ahead of the stop line L41 in the advancing direction. A dimension of area A42 may be the same as the dimension of area A21.

At both ends of the crosswalk C3, areas A43 and A44 that are crossing preparation areas are provided on the sidewalks in the same manner as the areas A22 and A23. Dimensions of the areas A43 and A44 are the same as the dimensions of the areas A22 and A23.

Predetermined host vehicle position conditions are set in advance for each of the areas A41 to A44. For example, host vehicle position conditions that are satisfied when a host vehicle position of the host vehicle 100 located in the lane R41 approaches a position a predetermined distance (for example, 5 m) ahead of the stop line L41 may be set in the area A41. The same host vehicle position conditions as those for the areas A21 to A23 in FIG. 3 may be set for the areas A42 to A44.

In the example in FIG. 5, the host vehicle 100 located in the lane R41 has not yet passed the stop line L41, and can thus enter the intersection X1 after temporarily stopping at the stop line L41. The other vehicle 102 located in the area A41 and a pedestrian W5 located in the area A42 are moving objects that are neither on the target path P4 of the host vehicle 100 nor in the lane R41 in which the host vehicle 100 is traveling.

Area information of the first type is assigned to the area A41. In this case, as recognition of the influence, it may be determined whether or not there is a risk of collision between the other vehicle 102 that is a moving object in the area A41, and the host vehicle 100. In a case where there is a risk of collision, vehicle control may be performed by decelerating the host vehicle 100 to avoid collision.

Area information of the second type is assigned to the area A42 of the second crosswalk area. In this case, it is not determined whether or not there is a risk of collision between the moving object in area A42 and the host vehicle 100 as recognition of the influence. It is determined whether or not the moving object in area A42 is a pedestrian W5. In a case where the moving object is the pedestrian W5, vehicle control is performed to decelerate the host vehicle 100 and stop the host vehicle 100 ahead of the stop line L41 in order to prioritize the crossing of the pedestrian W5. In a case of performing vehicle control on the area A42, the determination for the area A41 may be omitted in recognition of the influence. Area information of the first type is assigned to the areas A43 and A44.

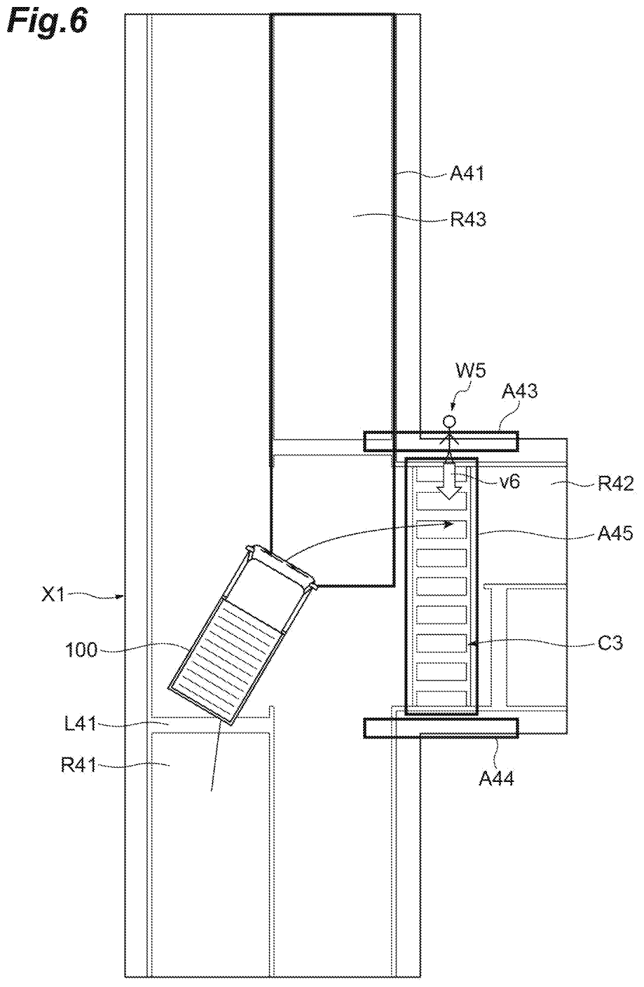

FIG. 6 is a plan view exemplifying a scene in which the host vehicle that is about to turn right at an intersection is crossing the stop line. FIG. 6 illustrates a situation in which a host vehicle position of the host vehicle 100 is different from that in FIG. 5 with respect to the same crosswalk C3 as in FIG. 5.

As illustrated in FIG. 6, a rectangular area A45 surrounding the crosswalk C3 is provided. The area A45 is a first crosswalk area that is an area in a case where the host vehicle 100 is located past the stop line L41 in the advancing direction. A dimension of the area A45 may be similar to the dimension of the area A42. That is, the crosswalk area may include the area A45 that is a first crosswalk area in a case where the host vehicle 100 is located past the stop line L41 in the advancing direction (in the case in FIG. 6), and the area A42 that is a second crosswalk area in a case where the host vehicle 100 is located ahead of the stop line L41 in the advancing direction (in the case in FIG. 5), with respect to one crosswalk C3.

In the example in FIG. 6, the host vehicle 100 located within the intersection X1 has crossed the stop line L41, and thus advances within the intersection X1 without temporarily stopping at the stop line L41. Area information of the first type is assigned to the area A45 that is a first crosswalk area. In this case, as recognition of influence, it is determined whether or not there is a risk of collision between a moving object (for example, pedestrian W5) in the crosswalk and the host vehicle 100. In a case where there is a risk of collision, vehicle control is performed by decelerating the host vehicle 100 to avoid collision.

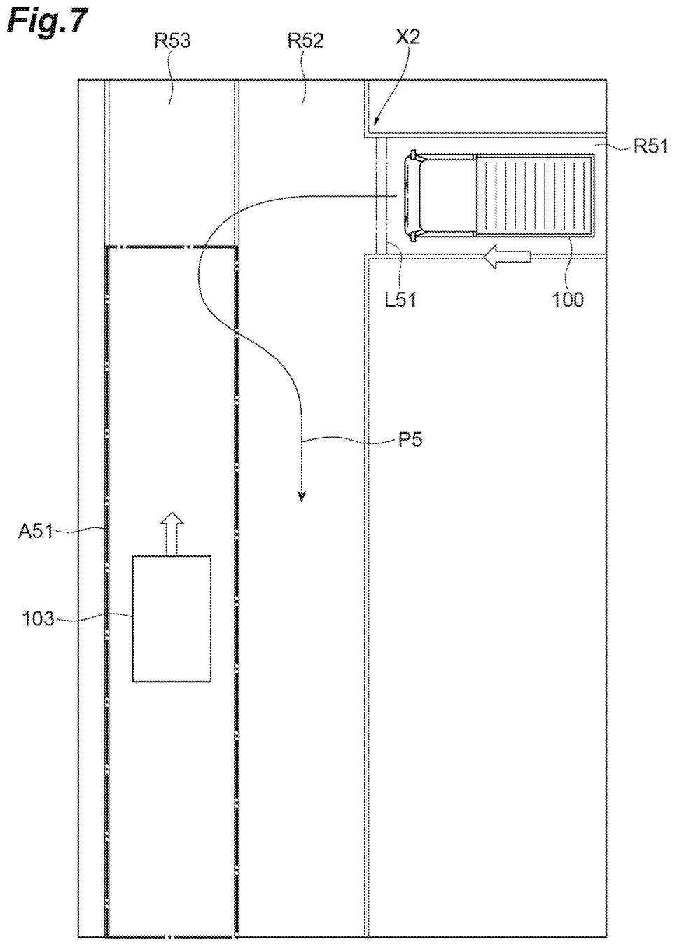

FIG. 7 is a plan view exemplifying a scene in which a host vehicle trajectory of the host vehicle about to turn left at an intersection protrudes into an oncoming lane. FIG. 7 exemplifies a lane R51 that is a narrow road, as a lane in which the host vehicle 100 is located. FIG. 7 exemplifies a lane R52 as a lane toward which the host vehicle 100 turns left at the intersection X2. No stop line is provided in the lane R51. In the map database 5, for example, a virtual stop position L51 may be set in advance at a position a predetermined distance from the end of the lane R51 on the map. That is, the map information includes position information of the stop position L51 on the lane R51 as stop position information.

In FIG. 7, in a case where the host vehicle 100 is, for example, a large vehicle, and turns left from the lane R5, a host vehicle trajectory (a traveling trajectory of the host vehicle 100) P5 expands outward into the oncoming lane R53. The host vehicle trajectory P5 may be set in advance based on results of actual traveling in advance. The host vehicle trajectory P5 may be calculated in advance by using a desktop simulation result.

In FIG. 7, as an example, an area A51 is provided on the oncoming lane R53 that can enter the intersection X2. The area A51 is, for example, a rectangular region having a width dimension that is substantially the same as a lane width of the oncoming lane R53. A dimension of the area A51 in the direction in which the lane extends is a dimension corresponding to a presence range of another vehicle 103 that may actually interfere with a possible future trajectory in a case where the host vehicle 100 located in the lane R51 turns left in consideration of a speed limit in the oncoming lane R53. The area A51 is not limited to a rectangular shape, and may have any shape along the oncoming lane R53.

The area A51 is a host vehicle protrusion area. The host vehicle protrusion area is an area preset for the intersection X2 where the host vehicle trajectory P5 protrudes into the oncoming lane R53 in a case where the host vehicle 100 turns left. In other words, the areas include a host vehicle protrusion area set in advance for the intersection X2 such that the host vehicle trajectory P5 protrudes into the oncoming lane R53 in a case where the host vehicle 100 turns left.

In the situation illustrated in FIG. 7, since a shape of the host vehicle trajectory P5 generally tends to be complicated, a computational load on the vehicle control apparatus 1 is likely to increase in a case where a risk of collision between the host vehicle trajectory P5 and the other vehicle 103 is calculated. Therefore, although recognition of influence is based on a determination result of whether or not the other vehicle 103 that is a moving object is present in the area A51 of the oncoming lane R53, computation is simplified by omitting other determinations. As a result, the computational load can be reduced compared with a case where the simplification is not performed.

Predetermined host vehicle position conditions are set in advance in the area A51. For example, host vehicle position conditions that are satisfied when a host vehicle position of the host vehicle 100 located in the lane R51 approaches a position a predetermined distance (for example, 5 m) ahead of the stop position LSI may be set in the area A51.

In the example in FIG. 7, the other vehicle 103 located in the area A51 is a moving object that is present neither on a target path (host vehicle trajectory P5) of the host vehicle 100 nor in the lane R51 in which the host vehicle 100 is traveling. Area information of the third type is assigned to the area A51 that is a host vehicle protrusion area. In the case of the third type, it is not determined whether or not there is a risk of collision between the moving object in the area A51 and the host vehicle 100. In a case where there is a moving object in the area A51, vehicle control is performed to decelerate the host vehicle 100 to be stopped ahead of the stop position L51 in order to give priority to the other vehicle 103 escaping from the area A51. Determination of the type of a moving object in the area A51 may also be omitted. In determining whether or not a moving object is present in the area A51 in the case of the third type, a stationary moving object may be excluded from determination targets. A “stationary moving object” is not limited to a completely stationary moving object. In the example in FIG. 7, in a case where a vehicle speed of the other vehicle 103 is equal to or less than a predetermined vehicle speed threshold, the other vehicle 103 within the area A51 may be excluded from determination targets. As a result, for example, in a case where the other vehicle 103 is parked in the area A51, it is possible to prevent the host vehicle 100 from continuing to stop ahead of the stop position.

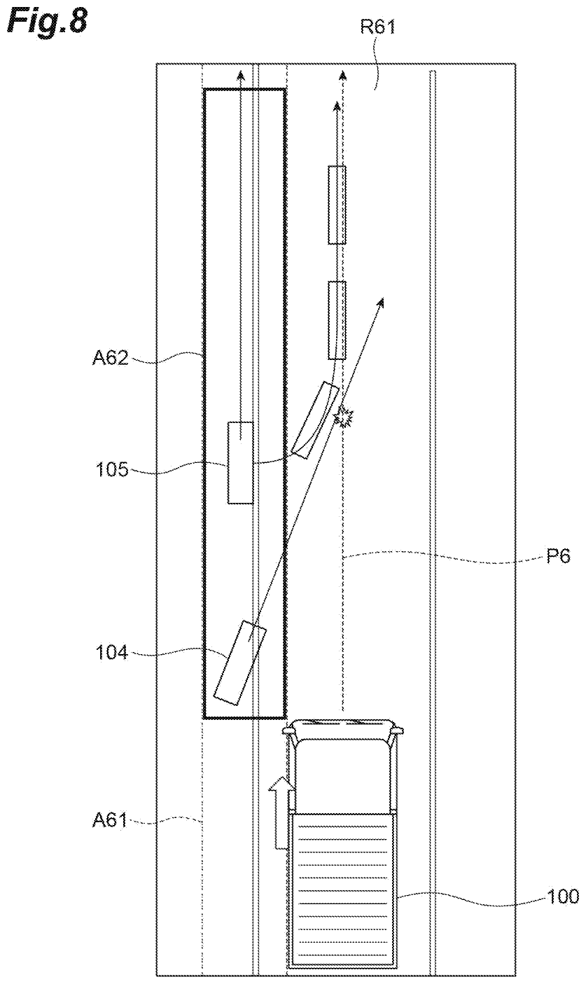

The area does not necessarily have to be a fixed region on the map. The area does not necessarily have to be a closed region on the map. The area may be preset as an open region on the map. The open region is, for example, a figure region having infinitely long sides in a predetermined direction. For example, FIG. 8 is a plan view illustrating an example of an area setting method. FIG. 8 illustrates, for example, a situation in which other vehicles 104 and 105 that are two-wheeled vehicles as moving objects are traveling diagonally to the left and ahead of the host vehicle 100 traveling in a lane R61.

In FIG. 8, as an example, a strip-shaped area A61 extending along the extending direction of the lane R61 is provided in a left portion of a lane width of the lane R61. The area A61 is defined, for example, as a strip-shaped region having a width dimension corresponding to a range in which a presence probability of the other vehicles 104 and 105 that are two-wheeled vehicles is high. The presence probability of the other vehicles 104 and 105 may be calculated in advance by taking into account positions in a vehicle width direction where it is easy for a two-wheeled vehicle traveling in the same lane as a passenger car or a large vehicle to travel, and a possibility that a two-wheeled vehicle will join the center of the lane or change course.

In this case, as a position of the host vehicle 100 moves from moment to moment in accordance with traveling of the host vehicle 100, the strip-shaped area A61 may be limited to a predetermined cut-off dimension in the extending direction of the lane, with the position of the host vehicle as a reference, and thus the area A62 may be set as a target area for recognizing the influence of a moving object. The predetermined cut-off dimension may be a dimension corresponding to a presence range of the other vehicles 104 and 105 that may actually interfere with the target path P6 of the host vehicle 100 traveling in the lane R61 by assuming the maximum speed of a two-wheeled vehicle in the lane R61.

In the example in FIG. 8, the area may also be a closed region. For example, a dimension of the area A62 along the advancing direction of the host vehicle 100 may be given in advance as a finite predetermined dimension. In this case, the relative positions of the other vehicles 104 and 105 with respect to the host vehicle 100 are used as a reference, and the area A62 may extend in the longitudinal direction of the other vehicles 104 and 105 with the above predetermined dimension. As a result, the area A62 that is a closed region moves in accordance with traveling of the host vehicle 100. The predetermined dimension may change according to a vehicle speed of the host vehicle 100. For example, the lower the vehicle speed of the host vehicle 100 is, the smaller the predetermined dimension may be.

Next, a functional configuration of the ECU 10 will be described. The ECU 10 has a host vehicle position recognizer 11, an external environment recognizer (moving object recognizer) 12, an influence recognizer 13, and a vehicle controller 14.

The host vehicle position recognizer 11 recognizes a host vehicle position that is a position of the host vehicle 100 on the map, by receiving a signal output from the GNSS receiver 2. The host vehicle position recognizer 11 may recognize the host vehicle position by estimating the host vehicle position using the LiDAR of the external sensor 3 and a high-precision point cloud map. The host vehicle position recognizer 11 may recognize a host vehicle position according to other known techniques.

The external environment recognizer 12 recognizes an external environment of the host vehicle 100 based on a detection result from the external sensor 3. The external environment recognizer 12 recognizes a moving object around the host vehicle 100 based on the detection result from the external sensor 3. The external environment recognizer 12 recognizes a velocity vector of the moving object (for example, v1 to v6 in FIGS. 2 to 6) based on, for example, a position of the moving object with respect to the host vehicle 100, a relative speed of the moving object with respect to the host vehicle 100, and a movement direction of the moving object with respect to the host vehicle 100. The external environment recognizer 12 may convert the relative position information of the moving object with respect to the host vehicle 100 acquired by the external sensor 3 into coordinates on the map in consideration of a result of own position estimation. Consequently, it is possible to consider the position of the moving object on the map.

The influence recognizer 13 recognizes the influence of the moving object on the host vehicle 100 traveling along the target path based on the recognition result from the external environment recognizer 12 and the target path of the host vehicle 100. The influence of the moving object on the host vehicle 100 is not particularly limited, but may be, for example, whether or not there is a risk that the moving object will collide with the host vehicle 100 based on the target path of the host vehicle 100 and the velocity vector of the moving object. The influence recognizer 13 recognizes a state of the host vehicle 100 during traveling based on the detection result from the internal sensor 4. The traveling state includes, for example, a vehicle speed, a vehicle acceleration, and a vehicle yaw rate.

Based on a host vehicle position of the host vehicle 100, area information, and a recognition result from the external environment recognizer 12, the influence recognizer 13 recognizes the influence of a moving object present in an area where the host vehicle position satisfies predetermined host vehicle position conditions set in advance for each area.

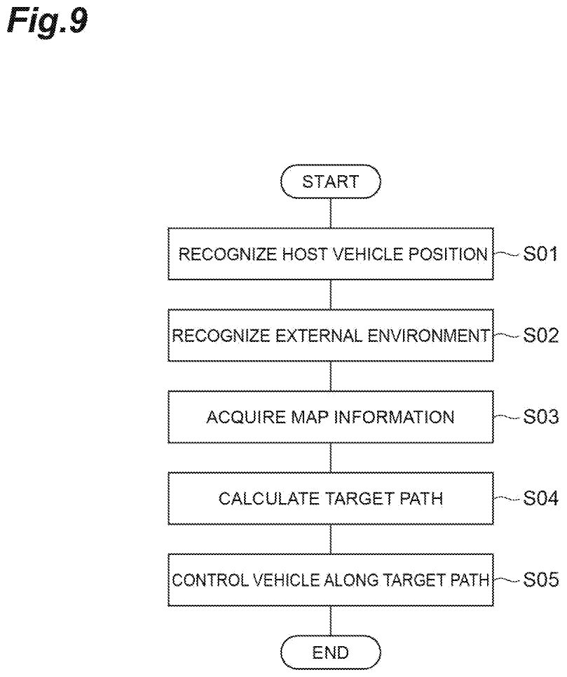

A target area is an area that is a target of recognition of the influence and is an area where a host vehicle position satisfies predetermined host vehicle position conditions set in advance for each area. As described above, in the cases of FIGS. 3 and 5, the host vehicle position conditions may be conditions satisfied when the host vehicle position of the host vehicle 100 approaches a predetermined distance (for example, 5 m) ahead of the stop line. It is possible to set the host vehicle position conditions as described above with reference to FIGS. 2 to 8. Specific processes of the influence recognizer 13 will be described later together with descriptions of flowcharts of FIGS. 9 to 13.

The vehicle controller 14 calculates a target path based on a host vehicle position and map information of the host vehicle 100. The target path is, for example, a path of the host vehicle 100 for autonomously driving the host vehicle 100 along a target route of the host vehicle 100. The vehicle controller 14 controls the drive actuator 21, the brake actuator 22, and the steering actuator 23 such that the host vehicle 100 travels along the calculated target path, and thus executes vehicle control for the host vehicle 100.

The vehicle controller 14 decelerates the host vehicle 100 to avoid collision with a moving object based on a recognition result from the influence recognizer 13. For example, in a case where the host vehicle 100 is decelerated to avoid collision with the moving object, the vehicle controller 14 may stop the host vehicle 100 ahead of the stop position based on the stop position information and the host vehicle position. In this case, the vehicle controller 14 may calculate a deceleration of the host vehicle 100 at which the host vehicle 100 can be stopped ahead of the stop line, and control the brake actuator 22 to achieve the calculated deceleration. The vehicle controller 14 may decelerate the host vehicle 100 to avoid collision with the moving object in a case where the moving object is present in the host vehicle protrusion area. Specific processes of the vehicle controller 14 will be described later together with descriptions of the flowcharts of FIGS. 9 to 13.

Next, processing of the ECU 10 of the vehicle control apparatus 1 will be described with reference to the drawings.

The processing of the ECU 10 will be described with reference to FIGS. 9 to 13. FIG. 9 is a flowchart illustrating an example of an autonomous driving process of the vehicle control apparatus in FIG. 1. The flowchart of FIG. 9 is executed, for example, under predetermined conditions in which autonomous driving can be performed on the host vehicle 100.

As illustrated in FIG. 9, in S01, the ECU 10 of the vehicle control apparatus 1 causes the host vehicle position recognizer 11 to recognize a host vehicle position that is a position of the host vehicle 100 on the map based on the position information of the GNSS receiver 2 and the map information of the map database 5, for example. The ECU 10 may recognize at least a vehicle speed of the host vehicle 100 based on a detection result from the internal sensor 4 in S01.

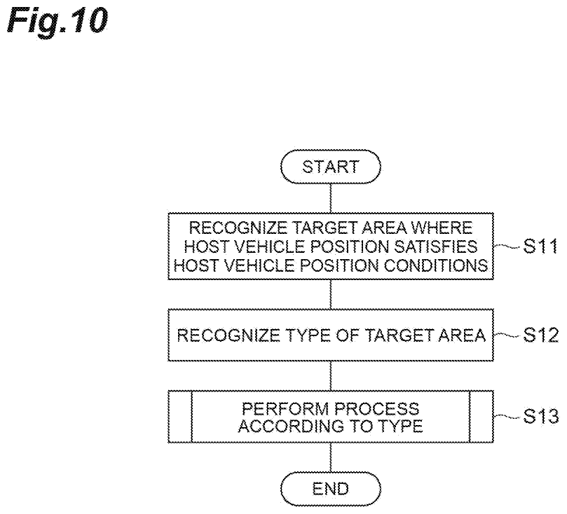

In S02, the ECU 10 causes the external environment recognizer 12 to recognize an external environment of the host vehicle 100 based on a detection result from the external sensor 3 and also recognize a moving object around the host vehicle 100. The external environment recognizer 12 recognizes a velocity vector of the moving object based on, for example, a position of the moving object with respect to the host vehicle 100, a relative speed of the moving object with respect to the host vehicle 100, and a movement direction of the moving object with respect to the host vehicle 100. The recognized moving object is used in the processing in FIGS. 10 to 13.

In S03, the ECU 10 causes the vehicle controller 14 to calculate a target path based on the host vehicle position of the host vehicle 100 and the map information.

In S04, the ECU 10 causes the vehicle controller 14 to calculate a target path for the host vehicle 100 based on, for example, the host vehicle position and a destination of the host vehicle 100, and the map information. The target path may be created in advance before traveling of the host vehicle 100. The target path may be created while the host vehicle 100 is traveling.

In S05, the ECU 10 causes the vehicle controller 14 to control the drive actuator 21, the brake actuator 22, and the steering actuator 23 such that the host vehicle 100 travels along the calculated target path, and thus executes vehicle control for the host vehicle 100. After that, the ECU 10 ends the processing in FIG. 9, and executes the processing in FIG. 9 again, for example, at predetermined intervals.

FIG. 10 is a flowchart illustrating an example of a collision avoidance process of the vehicle control apparatus 1. The flowchart of FIG. 10 is executed in parallel with the execution of the autonomous driving process in FIG. 9, for example.

As illustrated in FIG. 10, in S11, the ECU 10 causes the influence recognizer 13 to recognize a target area where the host vehicle position satisfies the host vehicle position conditions based on the host vehicle position of the host vehicle 100 and the area information.

For example, in a case where a distance between the host vehicle position of the host vehicle 100 and an outer edge of the area is equal to or shorter than a predetermined distance, the influence recognizer 13 recognizes the area as the target area. In this case, the host vehicle position satisfies the host vehicle position conditions. For example, in a case where the distance between the host vehicle position of the host vehicle 100 and the outer edge of the area is longer than the predetermined distance, the influence recognizer 13 does not recognize the area as the target area. In this case, the host vehicle position does not satisfy the host vehicle position conditions.

More specifically, for example, at an entrance of a roundabout, in a case where the host vehicle position is within a predetermined distance ahead of a stop position in the advancing direction, the influence recognizer 13 recognizes an upstream area that is an area on the upstream side of the host vehicle position inside the roundabout, as the target area.

For example, in a case where the host vehicle position is located past a stop position in the advancing direction before a crosswalk, the influence recognizer 13 recognizes a first crosswalk area and crossing preparation areas at both ends thereof as target areas. For example, in a case where the host vehicle position is located ahead of the stop position in the advancing direction before the crosswalk, the influence recognizer 13 recognizes a second crosswalk area and crossing preparation areas at both ends thereof as target areas. The phrase “before the crosswalk” may mean that the host vehicle 100 is located ahead of the crosswalk in the advancing direction on a straight road. The phrase “before the crosswalk” may mean that the host vehicle 100 is located ahead of the crosswalk located at the exit of the intersection in the advancing direction.

For example, at the entrance of an intersection, in a case where the host vehicle is within a range of a predetermined distance ahead of the stop position in the advancing direction or within the intersection, the influence recognizer 13 recognizes, as a target area, an oncoming lane area that is an area on an oncoming lane that can enter the intersection.

For example, in a case where the host vehicle position is present at an intersection where the host vehicle trajectory protrudes into the oncoming lane when the host vehicle 100 turns left, the influence recognizer 13 recognizes the host vehicle protrusion area of the intersection as a target area.

In S12, the ECU 10 causes the influence recognizer 13 to recognize the type of the target area based on the host vehicle position of the host vehicle 100 and area information of the target area. For example, in a case where the target area is at least one of the upstream areas, the crossing preparation area, the first crosswalk area, and the oncoming lane area, the influence recognizer 13 recognizes the type of the target area as a first type. For example, in a case where the target area is the second crosswalk area, the influence recognizer 13 recognizes the type of the target area as a third type. For example, in a case where the target area is the host vehicle protrusion area, the influence recognizer 13 recognizes the type of the target area as the second type.

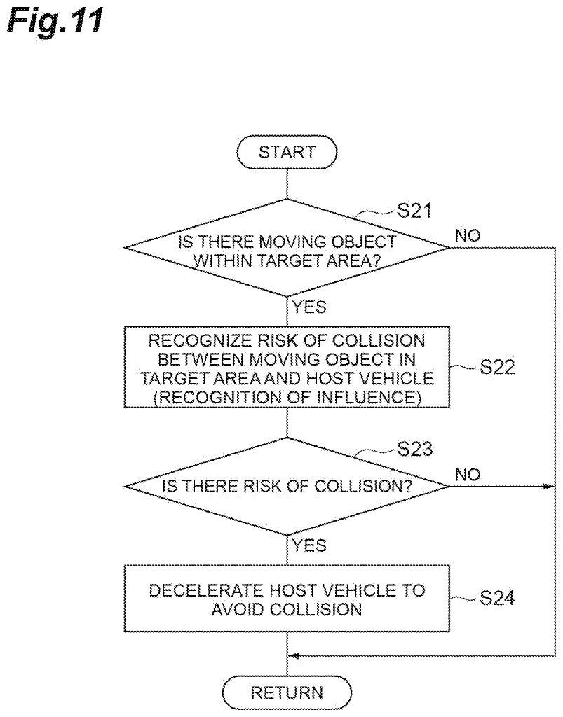

In S13, the ECU 10 causes the influence recognizer 13 and the vehicle controller 14 to perform processes according to the type of target area. Specifically, the ECU 10 performs processing in FIG. 11 in a case where the type of the target area is the first type.

As illustrated in FIG. 11, in S21, the ECU 10 causes the influence recognizer 13 to determine whether or not there is a moving object within the target area. In a case where it is determined that there is a moving object within the target area (S21: YES), the ECU 10 proceeds to the process in S22. In a case where it is determined that there is no moving object within the target area (S21: NO), the ECU 10 ends the processing in FIG. 11, returns to FIG. 10, and ends the processing in FIG. 10.

In S22, the ECU 10 causes the influence recognizer 13 to recognize a risk of collision between the moving object in the target area and the host vehicle 100 (recognition of influence) based on the target path of the host vehicle 100 and the velocity vector of the moving object. As the influence on the host vehicle 100, the ECU 10 predicts the movement of the moving object based on, for example, the velocity vector of the moving object, and recognizes a risk of collision between the host vehicle 100 advancing along the target path and the moving object. The ECU 10 may recognize the influence on the host vehicle 100 in the form of a collision risk value or the like.

In S23, the ECU 10 causes the influence recognizer 13 to determine whether or not there is a risk of collision between the host vehicle 100 advancing along the target path and the moving object. In a case where it is determined that there is a risk of collision between the host vehicle 100 advancing along the target path and the moving object (S23: YES), the ECU 10 proceeds to the process in S24. In a case where it is determined that there is no risk of collision between the host vehicle 100 advancing along the target path and the moving object (S24: NO), the ECU 10 ends the processing in FIG. 11, returns to FIG. 10, and ends the processing in FIG. 10.

In S24, the ECU 10 causes the vehicle controller 14 to decelerate the host vehicle 100 to avoid collision between the host vehicle 100 and the moving object. Thereafter, the ECU 10 ends the processing in FIG. 11, returns to FIG. 10, and ends the processing in FIG. 10.

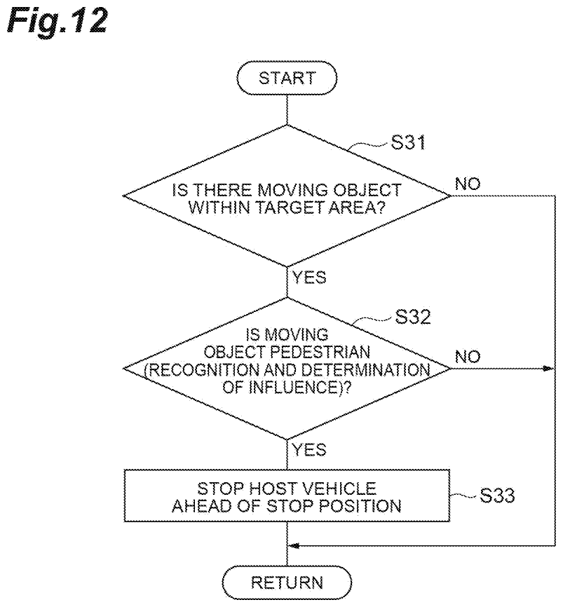

On the other hand, in a case where the type of the target area is the second type in S13 in FIG. 10, the ECU 10 performs the processing in FIG. 12. The ECU 10 may preferentially perform the processing in FIG. 12 in a case where a plurality of target areas do not include an area of the third type but include an area of the second type.

As illustrated in FIG. 12, in S31, the ECU 10 causes the influence recognizer 13 to determine whether or not there is a moving object within the target area (here, within the second crosswalk area). In a case where it is determined that there is a moving object within the target area (S31: YES), the ECU 10 proceeds to the process in S32. In a case where it is determined that there is no moving object within the target area (S31: NO), the ECU 10 ends the processing in FIG. 12, returns to FIG. 10, and ends the processing in FIG. 10.

In S32, the ECU 10 causes the influence recognizer 13 to determine whether or not the moving object in the target area is a pedestrian (recognition and determination of influence). In a case where it is determined that the moving object in the target area is a pedestrian (S32: YES), the ECU 10 proceeds to the process in S33. In a case where it is determined that the moving object in the second crosswalk area is not a pedestrian (S32: NO), the ECU 10 ends the processing in FIG. 12, returns to FIG. 10, and ends the processing in FIG. 10.

In S33, the ECU 10 causes the vehicle controller 14 to decelerate the host vehicle 100 and stop the host vehicle 100 ahead of the stop position. Thereafter, the ECU 10 ends the processing in FIG. 12, returns to FIG. 10, and ends the processing in FIG. 10.

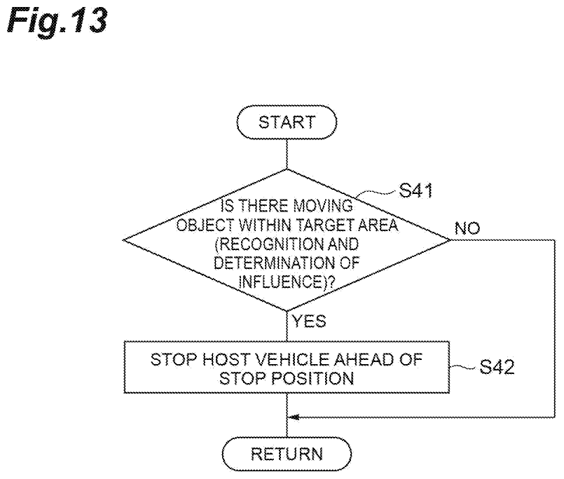

On the other hand, in a case where the type of the target area is the third type in S13 in FIG. 10, the ECU 10 performs the processing in FIG. 13. The ECU 10 may preferentially perform the processing in FIG. 13 in a case where the plurality of target areas include an area of the third type.

As illustrated in FIG. 13, in S41, the ECU 10 causes the influence recognizer 13 to determine whether or not there is a moving object within the target area (in this case, the host vehicle protrusion area) (recognition and determination of influence). In a case where it is determined that there is a moving object within the target area (S41: YES), the ECU 10 proceeds to the process in S42. In a case where it is determined that there is no moving object within the target area (S41: NO), the ECU 10 ends the processing in FIG. 13, returns to FIG. 10, and ends the processing in FIG. 10. In the processing in FIG. 13, stationary moving objects may be excluded. A “stationary moving object” is not limited to a completely stationary moving object. For example, in a case where a speed of a moving object is equal to or less than a predetermined threshold value, the moving object may be excluded from targets on which the processing in FIG. 13 is performed.

In S42, the ECU 10 causes the vehicle controller 14 to decelerate the host vehicle 100 and stop the host vehicle 100 ahead of the stop position. Thereafter, the ECU 10 ends the processing in FIG. 13, returns to FIG. 10, and ends the processing in FIG. 10.

As described above, the vehicle control apparatus 1 recognizes the influence of a moving object on the host vehicle 100, the moving object being a moving object that is present neither on a target path of the host vehicle 100 nor in a lane in which the host vehicle 100 is traveling. As a result, for example, in a case where there is a risk of collision with such a moving object, the host vehicle 100 can be decelerated at an early stage to avoid the collision. Since sudden braking can be prevented, it is possible to reduce obstruction of traffic of moving objects around the host vehicle 100. A target area that is a target of recognition of the influence is an area where the host vehicle position satisfies predetermined host vehicle position conditions set in advance for each area. As described above, since the influence is recognized by limiting a target area, an increase in a computational load can be suppressed compared with, for example, a case of recognizing the influence without area limitation (that is, in the entire sensing range of the external sensor 3). Therefore, according to the vehicle control apparatus 1, it is possible to reduce obstruction of traffic of moving objects around the host vehicle 100 while suppressing an increase in a computational load.

In the vehicle control apparatus 1, the area is preset as a closed region on the map. For example, in a case where the area is a preset open region, an additional computation process is required to be used for recognition of the influence. In contrast, according to the vehicle control apparatus 1, the computational load can be reduced compared with the case where the area is an open region.

In the vehicle control apparatus 1, the area is preset as a fixed region on the map. For example, in a case where the area is a region that is not fixed on the map, the area moves on the map in accordance with movement of the host vehicle position moment by moment as the host vehicle is traveling. In a case where the area moves, an additional computation process is required. In contrast, according to the vehicle control apparatus 1, the computational load can be reduced compared with a case where the area is a region that is not fixed on the map.

In the vehicle control apparatus 1, the map information includes stop position information regarding a stop position where the host vehicle 100 is temporarily stopped on a roadway. In a case where the host vehicle 100 is decelerated to avoid collision with a moving object, the vehicle controller 14 stops the host vehicle 100 ahead of the stop position based on the stop position information and the host vehicle position. As a result, for example, in a case where the host vehicle 100 is decelerated, when the host vehicle 100 approaches the stop position, the host vehicle 100 can be appropriately stopped at the stop position.

In the vehicle control apparatus 1, the area includes a crosswalk area. The vehicle controller 14 stops the host vehicle 100 ahead of the stop position in a case where a moving object present in the crosswalk area is a pedestrian. For example, in a case where the host vehicle 100 is not stopped ahead of the stop position, a computation process is required to further compute a risk of collision between the moving object present in the crosswalk area and the host vehicle 100. In contrast, according to the vehicle control apparatus 1, the computational load can be reduced compared with a case where the host vehicle 100 is not stopped ahead of the stop position.

In the vehicle control apparatus 1, the area includes a crosswalk area. The crosswalk area includes the first crosswalk area in a case where the host vehicle 100 is located past the stop position in the advancing direction, and the second crosswalk area in a case where the host vehicle 100 is located ahead of the stop position in the advancing direction, with respect to one crosswalk. As a result, details of the vehicle control for the host vehicle 100 with respect to one crosswalk may be varied according to on which side of the stop position the host vehicle 100 is located in the advancing direction.

In the vehicle control apparatus 1, the area includes a host vehicle protrusion area preset for an intersection where the host vehicle trajectory protrudes into an oncoming lane when the host vehicle 100 turns left. In a case where a moving object is present in the host vehicle protrusion area, the vehicle controller 14 decelerates the host vehicle 100 to avoid collision with the moving object. For example, in a case where the host vehicle 100 is not decelerated to avoid collision with a moving object, a computation process is required to further compute interference between the host vehicle protrusion area and the host vehicle trajectory. In contrast, according to the vehicle control apparatus 1, the computational load can be reduced compared with a case where the host vehicle 100 is not decelerated to avoid collision with a moving object.

In addition, there is a tendency for the external sensor 3 to detect a moving object relatively close to the host vehicle 100 compared with a case where the vehicle control apparatus 1 recognizes the influence over the entire sensing range of the external sensor 3, for example. Therefore, it is expected to reduce the influence of erroneous recognition of moving objects (objects). It is expected to reduce the influence of a recognition error of a velocity vector (speed and direction) of a moving object. According to these, it is possible to prevent the host vehicle 100 from being forced to be braked suddenly or stopped suddenly in an intersection due to a moving object that is present neither on a target path of the host vehicle 100 nor in a lane in which the host vehicle 100 is traveling. As a result, smooth autonomous driving of the host vehicle 100 is realized while reducing a risk of collision with a moving object without obstructing traffic of other moving objects.

[Modification example] Although the embodiments of the present disclosure have been described above, the present disclosure is not limited to the above embodiments. The present disclosure can be embodied in various forms with various modifications and improvements based on the knowledge of those skilled in the art, including the embodiments described above.

For example, in the above-described embodiments, the map information includes stop position information regarding a stop position where the host vehicle 100 is temporarily stopped on a roadway, but the map information is not limited to this. In a case where the host vehicle 100 is decelerated to avoid collision with a moving object, the vehicle controller 14 stops the host vehicle 100 ahead of the stop position, but the present disclosure is not limited to this. For example, instead of an intersection, even at a position on the map where stop position information is not included in the map information (for example, entrances and exits of shops lined up along a lane in which the host vehicle 100 is traveling), the vehicle controller 14 may decelerate the host vehicle 100 to avoid collision with a moving object. In this case, the host vehicle 100 may be stopped ahead of the moving object.

In the above embodiments, the area includes the crosswalk area, but does not necessarily have to include the crosswalk area. The crosswalk area does not necessarily have to include a first crosswalk area and a second crosswalk area for one crosswalk. For example, the crosswalk area may be at least one of a first crosswalk area and a second crosswalk area for one crosswalk.

In the above embodiments, the area includes the host vehicle protrusion area, but does not necessarily have to include the host vehicle protrusion area. The vehicle controller 14 may further recognize a risk of collision between a moving object and the host vehicle in a case where the moving object is present in the host vehicle protrusion area.

In the above embodiments, the ECU 10 of the host vehicle 100 is configured to execute autonomous driving control that does not require driver's driving operation, but the present disclosure is not limited to this. For example, the ECU 10 may have a cruise control function and a pre-crash braking function for controlling acceleration/deceleration along a straight-ahead path corresponding to a target path, as driving assistance for the host vehicle 100. The present disclosure may be applied when performing the pre-crash braking function as collision avoidance during cruise control. For example, the present disclosure may be applied when performing a collision warning function in addition to or instead of the pre-crash braking function as driving assistance for the host vehicle 100.

### REFERENCE SIGNS LIST

1: vehicle control apparatus, 5: map database, 11: host vehicle position recognizer, 12: external environment recognizer (moving object recognizer), 13: influence recognizer, 14: vehicle controller, 100: host vehicle.

1. A vehicle control apparatus comprising:
a host vehicle position recognizer configured to recognize a host vehicle position that is a position of a host vehicle on a map;
a moving object recognizer configured to recognize a moving object around the host vehicle;
a map database that stores map information;
an influence recognizer configured to recognize an influence of the moving object on the host vehicle traveling along a target path of the host vehicle based on a recognition result from the moving object recognizer and the target path; and
a vehicle controller configured to decelerate the host vehicle to avoid collision with the moving object based on the recognition result from the influence recognizer, wherein
the map information includes area information regarding a plurality of areas on the map for specifying the moving object that is a target of recognizing the influence, and
when the host vehicle position satisfies predetermined host vehicle position conditions set in advance for each area, the influence recognizer recognizes the influence of the moving object present in the area where the host vehicle position satisfies the host vehicle position conditions, based on the host vehicle position, the area information, and the recognition result from the moving object recognizer.

2. The vehicle control apparatus according to claim 1, wherein the areas are preset as closed regions on the map.

3. The vehicle control apparatus according to claim 1, wherein the areas are preset as fixed regions on the map.

4. The vehicle control apparatus according to claim 1, wherein
the map information includes stop position information regarding a stop position where the host vehicle is temporarily stopped on a roadway, and
the vehicle controller stops the host vehicle ahead of the stop position based on the stop position information and the host vehicle position when the host vehicle is decelerated to avoid collision with the moving object.

5. The vehicle control apparatus according to claim 4, wherein
the areas include a crosswalk area, and
the vehicle controller stops the host vehicle ahead of the stop position when the moving object present in the crosswalk area is a pedestrian.

6. The vehicle control apparatus according to claim 4, wherein
the areas include a crosswalk area, and
the crosswalk area includes a first crosswalk area in a case where the host vehicle is located past the stop position in an advancing direction and a second crosswalk area in a case where the host vehicle is located ahead of the stop position in the advancing direction, with respect to one crosswalk.

7. The vehicle control apparatus according to claim 1, wherein
the areas include a host vehicle protrusion area preset for an intersection where a host vehicle trajectory protrudes into an oncoming lane in a case where the host vehicle turns left, and
the vehicle controller decelerates the host vehicle to avoid collision with the moving object when the moving object is present in the host vehicle protrusion area.
